(19) United States
(12) Patent Application Publication
(10) Pub. No.: US 2003/0137829 A1
(43) Pub. Date: Jul. 24, 2003

(54) Shimmerlight aquarium illuminator

(76) Inventor: Bryan Keith Ayers, Hercules, CA (US)

Correspondence Address: Bryan K. Ayers, 506-2 Athena, Hercules, CA, 94547, US

(21) Appl. No.: 10/053,803

(22) Filed: Jan. 24, 2002

(51) Int. Cl. A01K 63/06; F21V 13/10; F21V 29/00

(52) U.S. Cl. 362/101; 362/294; 362/307; 119/266; 119/267

(57) ABSTRACT

The Shimmerlight Aquarium Illuminator differs from conventional flourescent or incandescent aquarium light hoods in that it generates rays of light in the water which have motion and increased contrast, rather than simply flat, uniform light. It has natural underwater light movement.

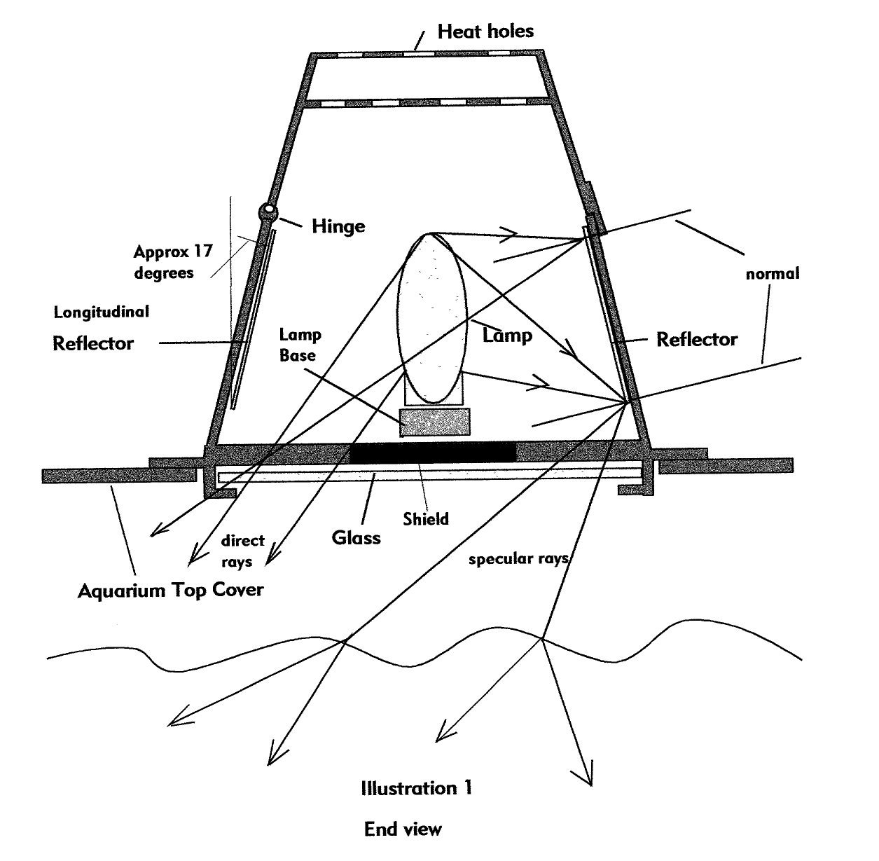

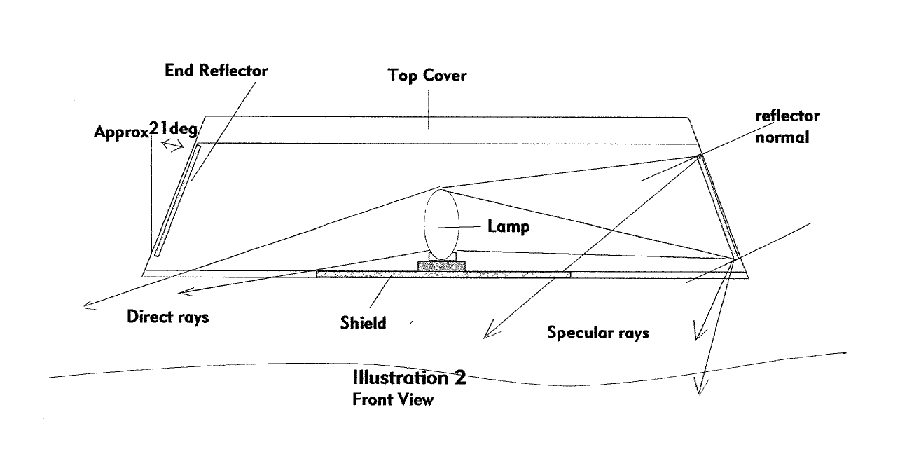

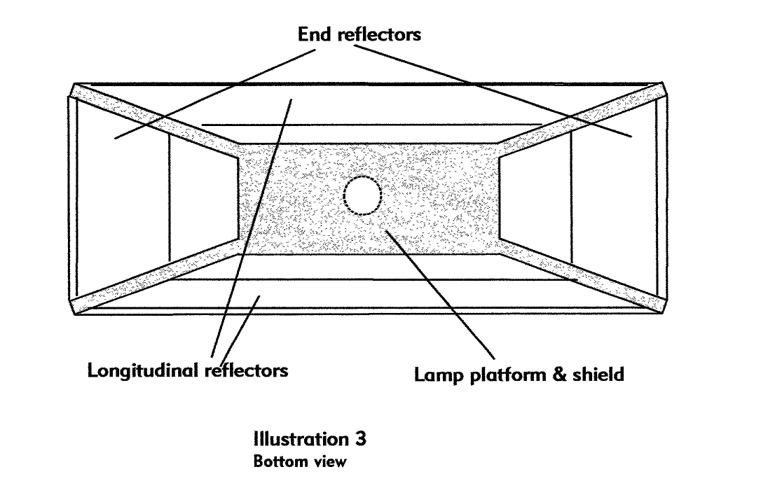

### BRIEF SUMMARY OF INVENTION

The Illuminator is an aquarium light hood that uses incandescent lamps and reflectors to produce in the aquarium a particular quality of illumination that is different than that produced by conventional flourescent or incandescent type hoods.

Whereas standard light hoods of the above type produce a generally uniform, flat light quality, the Illuminator produces specular and refracted light rays that have two main qualities: increased contrast and motion.

### BRIEF DESCRIPTION OF SEVERAL VIEWS OF DRAWING

Illustration 1 shows a representative hood configuration end view (looking the length of the aquarium) with heat escape holes, which are offset to prevent light from escaping, a hinged top for bulb access, removable glass bottom, and the relative location of the longitudinal reflectors to the lamp and their angle relative to vertical. Direct rays from the lamp to the water and reflected (specular) rays are depicted.

Illustration 2 is a front view of a single lamp/reflector assembly, seen from a perspective of facing the front of the tank. Direct and reflected light rays are shown. Angle of end reflectors is shown.

Illustration 3 is a fish eye view, showing the structure that supports the lamp and also prevents near to normal light rays from entering the water.

### DETAILED DESCRIPTION OF INVENTION

The Illuminator uses clear, high intensity incandescent lamps, halogen or similar, as the light source. Two primary forms of light enter the water:

Incident light. at angles of approx 30-60 degrees away from the normal of the water surface.

Reflected light-mirrorlike reflectors, positioned adjacent to the lamps, and situated both along and perpendicular to the axis of the hood, produce specular light which strikes the surface of the water at between 45 and 75 degrees from the normal at the water surface.

Light is prevented from entering the water at angles less than 30 degrees from the normal by a shield directly below the lamps.

The hood enclosure is otherwise similar to currently available models, constructed of high melting point, high impact plastic, with a transparent plastic or glass window on the bottom to prevent water intrusion, and heat vents on top.

The hood assembly may include a dimmer circuit so that the light intensity can be adjusted.

What I claim as my invention:

1. The essential difference between the Illuminator and conventional aquarium light hoods, whether they be of the flourescent variety or incandescent type, is that rather than generating flat, diffuse light, which illuminates the aquarium uniformly and with low contrast, this hood can produce distinct moving rays of light, which in turn also create higher contrast of illuminated objects.

2. The method is to use angles of incidence of the light to the water surface of not less than 15 degrees from the normal, and also employ a light source of sufficient concentration and intensity to produce the rays and also generate specular relections from mirrored surfaces inside the hood, which then also become rays directed at the surface of the water at the desired angles.

3. For the Illuminator to work in the manner intended, which is to achieve light motion, the surface of the water must have motion—ripples or bubbles.
It is the varying angles of refraction that result from both the angles of incidence and the water surface motion that creates the desired effect. If the water surface is smooth, the illumination is uniform and without motion.

4. The invention can be produced in scalable sizes—with a varying number of lamps/reflectors assemblies—to fit common aquarium sizes.
It may also include a dimmer control to vary light intensity. The glass or plastic bottom may be optically coated to adjust spectral content.
